(19) United States
(12) Patent Application Publication
(10) Pub. No.: US 2008/0222733 A1
(43) Pub. Date: Sep. 11, 2008

(54) Anti-pirate memory card

(75) Inventor: Chih Wen Cheng, Zhubei (TW)

Correspondence Address: BACON & THOMAS, PLLC, 625 SLATERS LANE, FOURTH FLOOR, ALEXANDRIA, VA, 22314-1176, US

(73) Assignee: DDTIC Corporation, Ltd., Zhubei City (TW)

(21) Appl. No.: 11/715,469

(22) Filed: Mar. 8, 2007

(51) Int. Cl. G06F 12/14

(52) U.S. Cl. 726/26

(57) ABSTRACT

An anti-pirate memory card is provided for preventing unauthorized reproduction, wherein the addresses of all bad blocks of each memory unit of the memory card are recorded during manufacturing process, and are converted into an identification code by a secret algorithm, and finally the identification code is written into a control chip and the memory unit. The memory card is effective in preventing software capture and hardware capture.

### FIELD OF THE INVENTION

The present invention relates to an improvement of the memory card, and more particularly to a memory card that can prevent piracy.

### BACKGROUND OF THE INVENTION

The existing desktop computer, notebook computer, mobile phone, PDA, digital camera, or similar products, are all provided with a built-in card reader that can read the data of a memory card. The types of the memory card include SD, MMC, Mini SD, FC, SDII, etc. The memory density of the memory card increases rapidly while the size is minimizing, therefore, the memory card has a tendency to replace the disc.

FIG. 1 shows a memory card 1 which comprises a control chip 11, a memory unit 12, and a lead 13 to be inserted in an electronic device 2. The content of the memory unit 12 of the memory card 1 is very likely to be pirated by the following methods:
1. using a memory writer to copy the data of the memory unit 12 directly;
2. when the content of the memory card 1 is displayed on the display of the electronic device 2, it can be read by a specially designed software, as shown in FIG. 2, this is called software capture.
3. when the content of the memory card 1 is displayed on the display of the electronic device 2, the content transmitted from the memory card 1 can be captured by hardware connections between the lead 13 and the electronic device 2, this is called hardware capture, as shown in FIG. 3.

The present invention has arisen to mitigate and/or obviate the afore-described disadvantages.

### SUMMARY OF THE INVENTION

The primary objective of the present invention is to provide an anti-pirate memory card capable of preventing unauthorized reproduction, wherein the addresses of all bad blocks of each memory unit of the memory card are recorded during manufacturing process, and are converted into an identification code by a secret algorithm, and finally the identification code is written into a control chip and the memory unit.

The secondary objective of the present invention is to prevent software capture, wherein the memory unit is divided into an ordinary area and a hidden area, the ordinary area is used to store proprietary software only. Pirate can reproduce the proprietary software but is unable to execute any action, because before execution, the proprietary software will check the existence of the memory card and check corresponding area based on the unique identification code, further, the proprietary software doesn't include protected electronic data, the protected electronic data is stored in the hidden area, and the content of the hidden area is written in a proprietary format, all ordinary electronic devices and software are inaccessible to the hidden area, except for the proprietary software.

The third objective of the present invention is to prevent hardware capture, wherein the memory card is designed such that the content of a memory unit of the memory card is displayed on a display of an electronic device connected to the memory card at dynamic frame rates of 22-32 frames per second. The scanning lines from the left to the right of the display are divided into odd numbered scanning lines and even numbered scanning lines, and the frame rate of the odd numbered scanning lines and that of the even numbered scanning lines are different, so as to prevent unauthorized hardware capture.

The content of the memory unit is written in cross-platform language format, such as xml, .Net, flash, Java, C language, which is applicable to desktop computer, notebook computer, mobile phone, PDA, digital camera, etc.

### BRIEF DESCRIPTION OF THE DRAWINGS

FIG. 1 shows a conventional memory card;

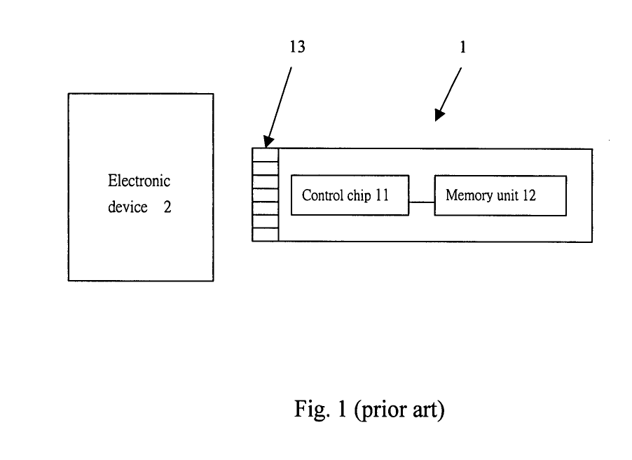

FIG. 2 illustrates the operation of software capture;

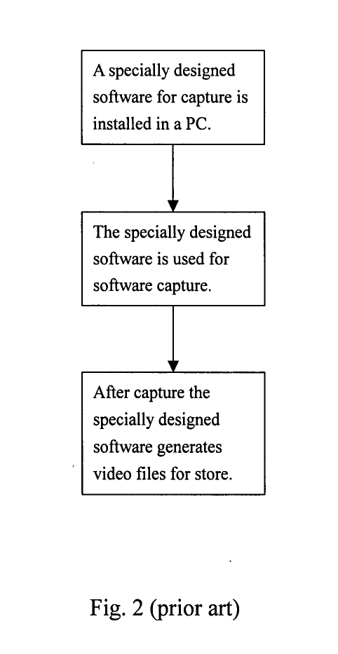

FIG. 3 is an illustrative view for showing the operation of hardware capture, wherein the hardware is connected to the computer to read the content transmitted from the memory card directly; and

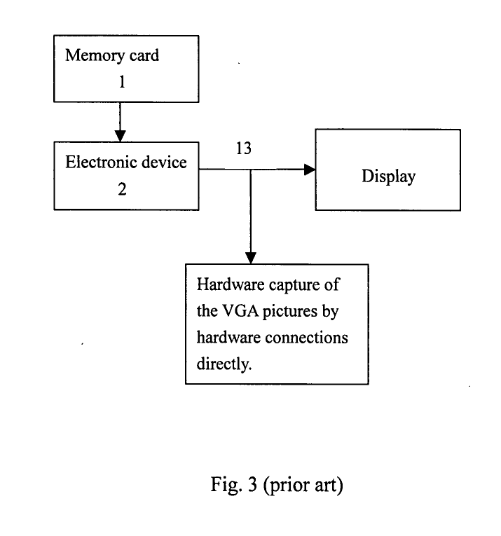

FIG. 4 is an illustrative view of the alternating dynamic speed method in accordance with the present invention.

### DETAILED DESCRIPTION OF THE PREFERRED EMBODIMENTS

To prevent a memory writer from pirating the data of a memory unit 12 without authorization, the present invention takes the following measures:

Since each memory unit 12 will produce a few bad blocks during manufacturing process, and the respective bad blocks of each memory unit 12 have different addresses, during the process of testing the memory unit 12 after the manufacturing process, the addresses of the bad blocks of each memory unit 12 can be recorded and converted into an identification code by a secret algorithm. After that, the unique identification code is written into the memory at a specific address during formatting and writing (burning) process. The identification code is written into the control chip 11 and the memory unit 12, only the control chip 11 and the memory unit 12 with the same identification code are matched with each other and can be used together, therefore, it is impossible to pirate the content of the memory unit 12 without authorization. Even if the pirate uses a memory writer to directly read the data of the memory unit 12 and obtains its identification code, the content still cannot be decoded because he doesn't know the secret algorithm.

The method of preventing software capture is to divide the memory unit 12 into two areas—an ordinary area and a hidden area. The ordinary area is used to store proprietary software only, pirate can reproduce the software but is unable to execute any action, because before execution, the proprietary software will check the existence of the memory card, and check the corresponding area based on the unique identification code. Further, the proprietary software doesn't include the protected electronic data. The protected electronic data is stored in the hidden area, and the content of the hidden area is written in proprietary format. Ordinary electronic devices and software are inaccessible to this area, except for the proprietary software of the present invention. The system of the present invention is effective in preventing the unauthorized reproduction of the data of the software.

The method of preventing the hardware capture is described as follows:

Since the content of the memory unit 12 is displayed on the display of the electronic device 2 at a frame rate of 15-30 frames per second, achieving an effect by persistence of vision, therefore, both the software capture and the hardware capture device must be in consistent with the frame rate of the content played on the display of the electronic device 2, otherwise the content of the memory unit 12 cannot be recorded completely. The memory card 1 in accordance with the present invention is designed to have a “dynamic speed method”, that is, the frame rate of the content of the memory unit 12 displayed on the display of the electronic device 2 changes randomly from 22 to 32 frames per second, and this method can prevent unauthorized hardware scanning.

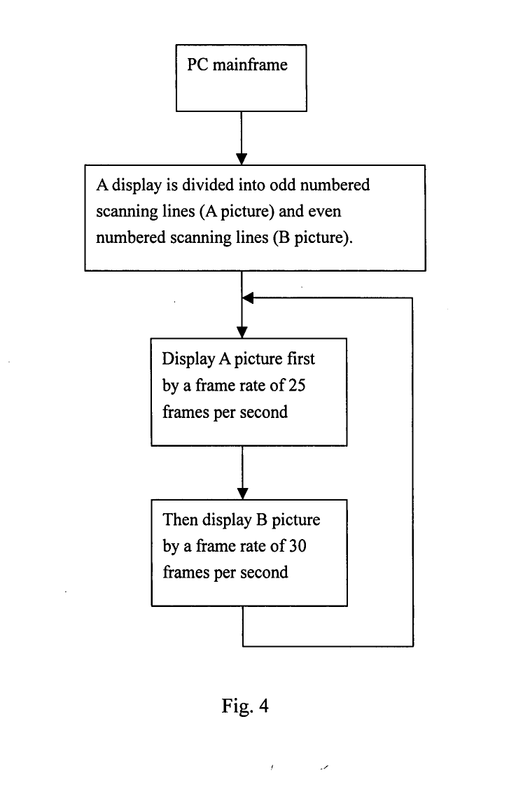

In addition to the dynamic speed method, the present invention is further designed with an “alternating dynamic speed method”. The scanning lines from the left to the right of the display are divided into odd numbered scanning lines and even numbered scanning lines, and the frame rate of the odd numbered scanning lines and that of the even numbered scanning lines are different. For example, the frame rate of the odd numbered scanning lines is 25 frames per second, and the frame rate of the even numbered scanning lines is 30 frames per second, and they change randomly and dynamically, as shown in FIG. 4. And this method can improve the effect of preventing the unauthorized hardware capture.

The memory card 1 in accordance with the present invention is applicable to various electronic devices, such as desktop computer, notebook computer, mobile phone, PDA, digital camera, etc. The content of the memory unit 12 is written in cross-platform language format that is selected from the group consisting of xml, flash, Java, .Net and C language format. The operating system of the existing desktop computer, notebook computer, mobile phone, PDA, digital camera supports the cross-platform language format, therefore, the memory card 1 of the present invention is suitable for use in all the above-mentioned electronic devices.

While we have shown and described various embodiments in accordance with the present invention, it is clear to those skilled in the art that further embodiments may be made without departing from the scope of the present invention.

What is claimed is:

1. An anti-pirate memory card, addresses of all bad blocks of each memory unit of the memory card are recorded during manufacturing process and converted into an identification code by a secret algorithm, and then the identification code is written into a control chip and the memory unit.

2. The anti-pirate memory card as claimed in claim 1, wherein the memory unit is divided into an ordinary area and a hidden area, the ordinary area is used to store proprietary software only, the proprietary software will check the existence of the memory card and check corresponding area based on the identification code, further, the proprietary software doesn't include protected electronic data, the protected electronic data is stored in the hidden area, and content of the hidden area is written in proprietary format, all ordinary electronic devices and software are inaccessible to the hidden area, except for the proprietary software.

3. An anti-pirate memory card, being designed such that content of a memory unit of the memory card is displayed on a display of an electronic device connected to the memory card at random frame rates from 22 to 32 frames per second, so as to prevent unauthorized hardware capture.

4. The anti-pirate memory card as claimed in claim 3, wherein scanning lines from left to right of the display are divided into odd numbered scanning lines and even numbered scanning lines, and a frame rate of the odd numbered scanning lines and that of the even numbered scanning lines are different, so as to further prevent unauthorized hardware capture.

5. The anti-pirate memory card as claimed in claim 1, wherein the content of the memory unit is written in cross-platform language format that is applicable to desktop computer, notebook computer, mobile phone, PDA, digital camera, etc.

6. The anti-pirate memory card as claimed in claim 2, wherein the content of the memory unit is written in cross-platform language format that is applicable to desktop computer, notebook computer, mobile phone, PDA, digital camera, etc.

7. The anti-pirate memory card as claimed in claim 3, wherein the content of the memory unit is written in cross-platform language format that is applicable to desktop computer, notebook computer, mobile phone, PDA, digital camera, etc.

8. The anti-pirate memory card as claimed in claim 4, wherein the content of the memory unit is written in cross-platform language format that is applicable to desktop computer, notebook computer, mobile phone, PDA, digital camera, etc.

9. The anti-pirate memory card as claimed in claim 5, wherein the cross-platform language format is selected from the group consisting of xml, flash, Java, .Net and C language format.

10. The anti-pirate memory card as claimed in claim 6, wherein the cross-platform language format is selected from the group consisting of xml, flash, Java, .Net and C language format.

11. The anti-pirate memory card as claimed in claim 7, wherein the cross-platform language format is selected from the group consisting of xml, flash, Java, .Net and C language format.

12. The anti-pirate memory card as claimed in claim 8, wherein the cross-platform language format is selected from the group consisting of xml, flash, Java, .Net and C language format.
